(19) United States
(12) Patent Application Publication
(10) Pub. No.: US 2004/0160516 A1
(43) Pub. Date: Aug. 19, 2004

(54) Light beam display employing polygon scan optics with parallel scan lines

(76) Inventor: Eric Harlen Ford, La Canada, CA (US)

Correspondence Address: David L. Henty, Myers Dawes Andras & Sherman, LLP, Suite 1150, 19900 MacArthur Blvd., Irvine, CA, 92612, US

(21) Appl. No.: 10/779,986

(22) Filed: Feb. 17, 2004

Related U.S. Application Data
(60) Provisional application No. 60/447,901, filed on Feb. 19, 2003.

(51) Int. Cl. H04N 3/08

(52) U.S. Cl. 348/203

(57) ABSTRACT

A light beam display employs a polygon reflector to scan one or more light beams in horizontal scan lines on a display screen. A horizontal scan line correction lens is provided in the optical path between the display screen and the polygon reflector to correct scan line bowing. An optical mechanical element is provided for vertically shifting the light beams so as to illuminate different scan lines of the display screen. Control electronics is employed to adjust the timing on a line by line basis to correct vertical pixel line distortion introduced by the correction lens.

### RELATED APPLICATION INFORMATION

The present application claims priority under 35 USC 119 (e) to provisional application serial No. 60/447,901 filed Feb. 19, 2003, the disclosure of which is incorporated herein by reference.

### BACKGROUND OF THE INVENTION

1. Field of the Invention

The present invention relates to displays and methods of displaying video information. More particularly, the present invention relates to light beam displays and methods of scanning light beams to display video information.

2. Description of the Prior Art and Related Information

High resolution displays have a variety of applications, including computer monitors, HDTV and simulators. Although light beam based displays such as light emitting diode or laser beam displays potentially can provide many advantages for such displays, such displays have not been widely employed. This is due in large part to limitations in the ability to scan the light beam over the display screen with the needed accuracy. One conventional approach to scanning a laser beam employs a rotating mirror to scan the laser beam in a linear direction as the mirror rotates. Typically, the mirror is configured in a polygon shape with each side corresponding to one scan length of the laser beam in the linear direction. A vertical shifting of the beam may typically be provided by a second mirror to provide a two dimensional scanning such as is needed for a display application.

An example of such a rotating polygon laser beam XY scanner is illustrated in FIG. 1. The prior art laser beam scanning apparatus shown in FIG. 1 employs a polygon shaped mirror 1 which receives a laser beam provided by laser 2 and deflects the laser beam in a scanning direction X as the polygon 1 rotates. A second mirror 3 is configured to shift the beam vertically in the Y direction so as to scan consecutive horizontal lines. The two mirrors thus scan the full X direction and full Y direction, respectively. Such polygon scanners have existed for many years, and have been used for tasks such as laser scanners, fiche readers, one axis of a raster scan system, etc. The common trait of all of these uses is that the polygon is used to scan a light beam that enters onto and exits from the polygon surface in the plane of the scan rotation. The reason that the polygon has mostly been used in this manner rather than for more complex uses is that if the light beam strikes the polygon surface at an inclined angle to the scan rotation, then the resulting scan line is curved when projected onto a flat surface as shown in FIG. 1. This phenomenon of scan line bowing is well known and is one of the aberrations to be avoided when building light beam(s)-type scanners.

The aforementioned scan line bowing distorts any image displayed by the polygon scanner which limits the usefulness of a polygon scanner for a raster-scanned display. Furthermore, it will be appreciated by those skilled in the art that as the size of the display and the resolution of the display increase this problem becomes more severe. Therefore, this problem would render a polygon scanned light beam display impractical for HDTV or other high quality and large screen applications. A number of previous attempts have been made to cure this problem, but all of them used insufficient methods, such as anamorphic pre-scan optics to minimize the out-of-scan-plane angle. These methods have failed, and therefore no method has successfully used the polygon as the sole scanning element in a commercially acceptable scanned laser or light beam display.

Accordingly, a need presently exists for a scanned light beam display which can provide accurate scanning of parallel scan lines. Furthermore, a need presently exists for such a display which does not add unduly to the cost or complexity of the display.

### SUMMARY OF THE INVENTION

In a first aspect, the present invention provides a light beam display comprising a display screen having a vertical and a horizontal dimension and a source of one or more light beams. The light beam display further comprises an optical path between the display screen and the light beam source for directing the one or more light beams to the display screen, including a movable reflector having a plurality of reflective facets for providing horizontal scanning of the light beams. A horizontal scan line distortion correction lens in the optical path corrects scan line bowing in the horizontal lines. The light beam display further comprises an optical mechanical element for vertically shifting the light beams so as to illuminate different scan lines of the display screen. Control electronics is provided for controlling the scan timing to compensate for varying scan line length introduced by the horizontal scan line distortion correction lens.

In a preferred embodiment the movable reflector is a rotatable polygon and the light beam source comprises an array of LED's. The horizontal scan line distortion correction lens provides an optical distortion substantially greater than an f-theta lens. In particular, the horizontal scan line distortion correction lens preferably has maximum optical distortion in a range between about 10% greater distortion and 500% greater distortion than an f-theta lens through a horizontal field angle of 8-28 degrees. The horizontal scan line correction lens may comprise an aspheric lens. The optical path further comprises a collimating lens. The horizontal distortion correction lens is preferably configured in the optical path between the display screen and movable reflector and the collimating lens is configured in the optical path on the opposite side of the movable reflector. The collimating lens introduces distortion into the plural light beams substantially opposite to the horizontal scan line distortion correction lens. The horizontal distortion correction lens may be an assembly of lens elements collectively providing the desired distortion. The light beam display may further comprise an input for receiving video data. The video data includes a plurality of horizontal lines of display information and the control electronics comprises a memory for storing video data and a timing control circuit for controlling timing of read out of video data from the memory in accordance with the horizontal line number of the video data. The timing control circuit preferably comprises a pixel clock converter for adjusting the pixel clock for each scan line and a start of line converter for adjusting the start timing for each scan line. The pixel clock converter increases the pixel clock rate for scan lines closer to the edge of the display. The start of line converter in turn provides a variable delay as the scan lines are closer to the edge of the display.

In a further aspect the present invention provides a method of displaying information on a display screen employing one or more light beams. The method comprises directing a light beam to the display screen via an optical path including a movable reflector having plural reflective facets, and scanning the light beam in a horizontal direction using the movable reflector to trace out a horizontal scan line. The method further comprises distorting the light beam while traversing the optical path to correct nonlinearity in the horizontal scan line introduced by the movable reflector. The method further comprises shifting the light beam in the vertical direction and adjusting the timing of the scanning based on the vertical position of the horizontal line in the screen to correct scan length distortion.

In a preferred embodiment of the method of displaying information on a display screen employing one or more light beams the adjusting of the timing is performed on a line by line basis. Adjusting of the timing preferably comprises controlling the rate of read out of horizontal lines of video information from a video memory based on the horizontal line being scanned. The read out rate is altered nonlinearly with horizontal line number. Adjusting of the timing further comprises controlling the start of line timing based on the horizontal line being scanned. Distorting the light beam comprises providing a distortion greater than an f-theta lens. The distortion is preferably between about 10% and 500% greater than the distortion of an f-theta lens through a horizontal scan field angle of about 8-28 degrees. The movable reflector is preferably a rotatable polygon reflector.

In a further aspect the present invention provides a light beam scanning system comprising a source of one or more light beams. The light beam scanning system further comprises a rotatable polygon having a plurality of reflective sides, configured to intercept the one or more light beams and scan the one or more light beams in a first direction to create a first scan line. The light beam scanning system further comprises means for shifting the one or more beams to create plural additional scan lines displaced in a second direction from the first scan line. The light beam scanning system further comprises means for distorting the one or more light beams to correct bowing of the scan lines but which introduces distortion in the second direction. The light beam scanning system further comprises timing means for correcting the distortion in the second direction.

In a preferred embodiment of the light beam scanning system the means for distorting comprises a lens having distortion greater than an f-theta lens. For example, the lens may have distortion between about 10% and 500% greater than an f-theta lens through at least a portion of the field angle. The timing means preferably provides a variable timing delay based on the amount of shifting of the scan lines in the second direction. The timing means also preferably provides a variable pixel clock rate based on the amount of shifting of the scan lines in the second direction.

In a further aspect the present invention provides the method for correcting scan line bowing in a rotatable polygon reflector light beam scanning system. The method comprises distorting the light beam by an amount substantially greater than the distortion provided by an f-theta lens to remove the scan line bow introduced by the rotatable polygon reflector. The method further comprises correcting scan line length variation introduced by the distorting.

In a preferred embodiment of the method for correcting scan line bowing the distorting provides a maximum distortion between about 10% and 500% greater than the maximum distortion of an f-theta lens through a field angle of 8-28 degrees. The correcting of scan line length variation may comprise adjusting the start of line timing. The correcting of scan line length variation may further comprise adjusting the scan line length by adjusting a pixel clock rate for the scan line.

Further aspects of the present invention will be appreciated by the following detailed description of the invention.

### BRIEF DESCRIPTION OF THE DRAWINGS

FIG. 1 is a schematic view of a prior art laser scanning apparatus.

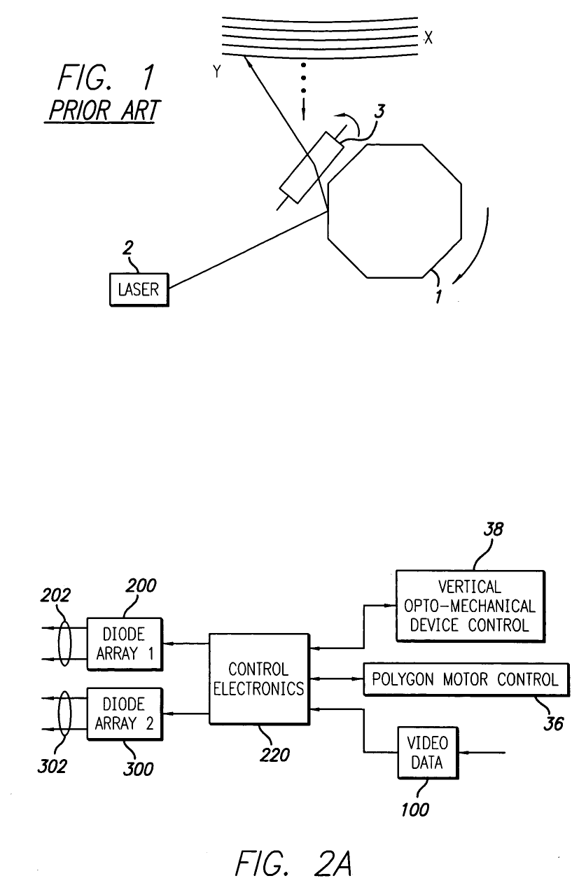

FIG. 2A and FIG. 2B are schematic drawings of a light beam display in accordance with a preferred embodiment of the present invention.

FIG. 3 is a schematic drawing of a scan line nonlinearity correction lens and scan pattern provided in accordance with one embodiment of the present invention.

FIG. 4 is a schematic drawing of a scan line nonlinearity correction lens and scan pattern provided in accordance with another embodiment of the present invention.

FIG. 5 is a graph of image height vs. field angle for a correction lens in accordance with the present invention compared to a conventional and f-theta lens.

FIG. 6 is a block diagram of the control electronics of the present invention providing timing correction to correct for scan line distortion introduced by the correction lens in accordance with a preferred embodiment of the invention.

FIG. 7 is a graph of the timing correction implemented by the control electronics of the present invention to correct for scan line distortion introduced by the correction lens in accordance with a preferred embodiment of the invention.

FIG. 8 is a drawing of a scan pattern showing distortion in scan line length introduced by the scan line nonlinearity correction lens of the present invention.

FIG. 9 is a drawing of the scan pattern showing equalization of scan line length by the control electronics of the present invention with residual line edge distortion.

FIG. 10 is a drawing of the scan pattern showing correction of residual scan line edge distortion by the control electronics of the present invention.

### DETAILED DESCRIPTION OF THE INVENTION

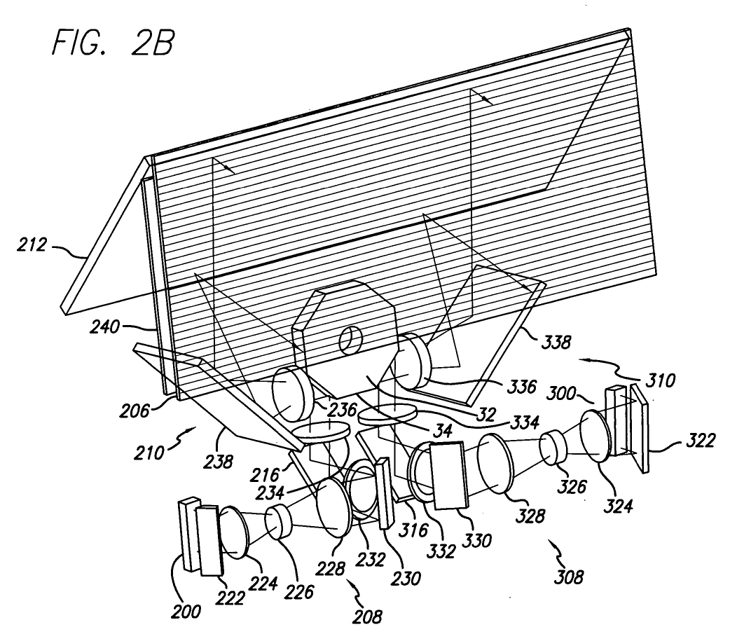

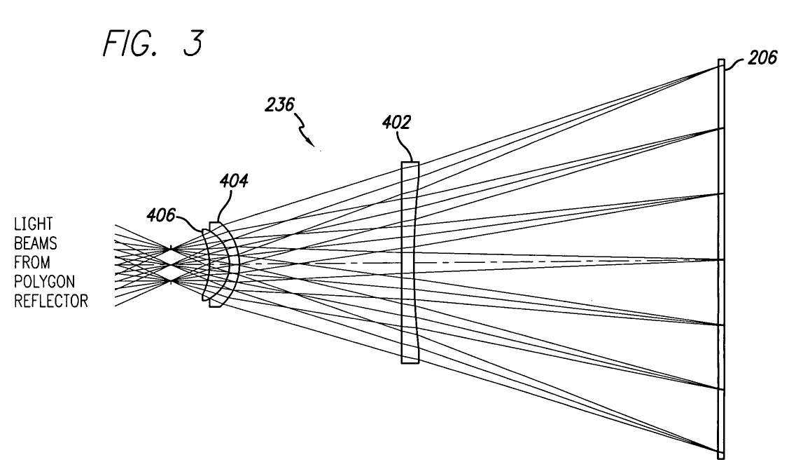

Referring first to FIG. 2A and FIG. 2B, a preferred embodiment of the light beam display of the present invention is illustrated in a schematic drawing illustrating the basic structure and electronics of the embodiment. A detailed discussion of the scan optics providing parallel scan lines without scan line bowing will be described in relation to FIGS. 3-10.

FIG. 2B illustrates the basic optical components of the display and FIG. 2A illustrates the electronics. The dimensions of the structural components and optical path are not shown to scale in FIG. 2B, and the specific dimensions and layout of the optical path will depend upon the specific application. Also, the light beam display may employ various features and aspects not described in detail herein. For example, the display may employ interlaced scanning as disclosed in U.S. patent application Ser. No. 10/000,945, filed Oct. 24, 2001, the disclosure of which is incorporated herein by reference in its entirety. The light beam display may also employ the teachings of U.S. Pat. No. 6,175,440, issued Jan. 16, 2001; U.S. Pat. No. 6,008,925 issued Dec. 28, 1999; U.S. Pat. No. 5,646,766 issued Jul. 8, 1997 and U.S. Pat. No. 5,166,944 issued Nov. 24, 1992; the disclosures of which are incorporated herein by reference. Accordingly, the following will not describe in detail all aspects of the display and reference may be made to the above noted patents for additional details and alternative or optional features.

The display of FIG. 2A and FIG. 2B includes a first source 200 of a plurality of light beams 202, which plural beams may include beams of different frequencies/colors as discussed in detail below, and a first optical path for the light beams between the light source 200 and a display screen 206. A second source 300 of a plurality of beams 302 is also provided, with a generally parallel second optical path to display screen 206. The beam activation is controlled by control electronics 220 in response to video data from source 100, in a manner described in more detail below. As one example of a presently preferred embodiment, the light sources 200, 300 may each comprise a rectangular array of light emitting diodes having a plurality of rows and at least one column. A monochrome display may have a single column for each diode array whereas a color display may have 3 or more columns. Also, additional columns may be provided for light intensity normalization. For example, two green columns could be provided where green diodes provide lower intensity light beams than red and blue diodes. A color array thus provides the 3 primary colors for each row. The number of rows corresponds to the number of parallel scan lines traced out on the display screen 206 by each diode array. For example, 1-32 rows of diodes may be employed. Each two-dimensional diode array 200, 300 may thus provide from 1 to 96 separate light beams 202, 302 simultaneously (under the control of control electronics 220, providing a scan pattern on the screen as discussed below). The number of light sources (such as LEDs or fibers) per delivery head 200, 300 may vary depending on the resolution requirements. Other sources of a plurality of light beams may also be employed. For example, a single beam may be split into a plurality of independently modulated beams using an AOM modulator, to thereby constitute a source of a plurality of beams. Such an approach for creating plural beams using an AOM modulator is described in U.S. Pat. No. 5,646,766, incorporated hereby by reference.

As further illustrated schematically in FIG. 2A and FIG. 2B the optical paths provide the plurality of light beams 202, 302 simultaneously on respective facets 34 of the rotating reflector 32 to illuminate two panels of screen 206. In particular, plural beams 202 are simultaneously directed to respective spots or pixels on a first panel or section of display 206 via a first facet. Plural beams 302 are in turn simultaneously directed to a different set of pixels on a second panel or section of display 206 via a second facet. To provide a seamless image an overlap region may be provided. The illustrated embodiment is thus a two panel display with two LED arrays acting as the light beam source for the respective display regions or panels on the display screen. Although a two panel/two light beam array embodiment is shown it should be appreciated that more panels may be provided, e.g. a four panel display may be preferred for large screen applications. Also, a single panel/single light beam array may also be employed in some applications.

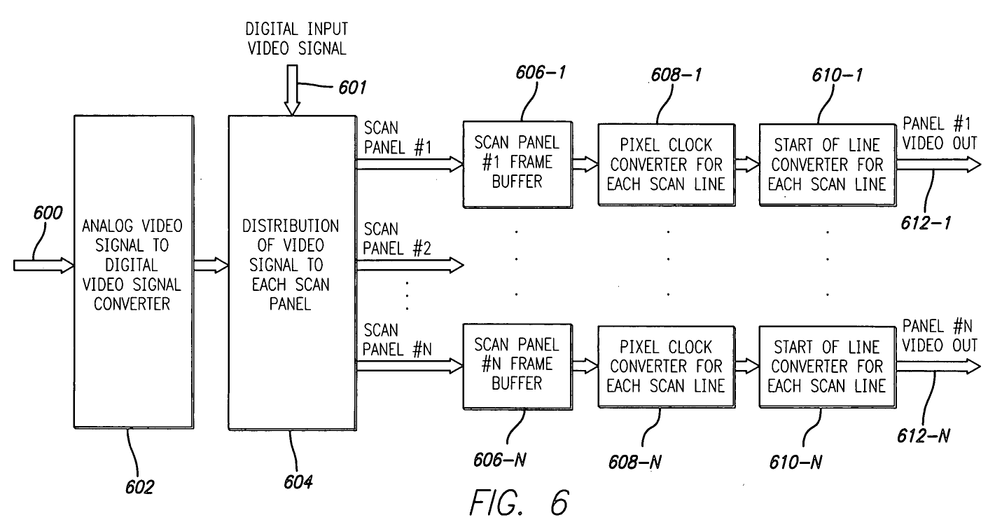

Movable reflector 32 for horizontal scanning preferably comprises a multifaceted polygon reflector 32. Accordingly, the horizontal scan lines generated by the polygon reflector will inherently have scan line bow. The solution of this problem is discussed below in relation to FIGS. 6-10. The number of facets on the polygon may vary depending on the screen size and resolution requirements. The polygon shaped reflector 32 is preferably coupled to a variable speed motor which provides for high speed rotation of the reflector 32 such that successive flat reflective facets 34 on the circumference thereof are brought into reflective contact with the light beams. The rotational speed of the reflector 32 is monitored by an encoder (not shown) which in turn provides a signal to motor control circuit 36 which is coupled to the control electronics 220. The motor control circuitry, power supply and angular velocity control feedback may employ the teachings in the above noted U.S. Pat. No. 5,646,766. Although a polygon shaped multi-faceted reflector 32 is presently preferred, it will be appreciated that other forms of movable multi-sided reflectors may also be employed to consecutively bring reflective flat surfaces in reflective contact with the light beams. Such alternate reflectors may be actuated by any number of a wide variety of electromechanical actuator systems, including linear and rotational motors, with a specific actuator system chosen to provide the desired speed of the facets for the specific application. A vertical optical-mechanical device or element 216, 316 for each set of beams 202, 302 provides vertical shifting of the beams under the control of circuitry 38 and control electronics 220. The vertical optical-mechanical device or element 216, 316 may comprise a second movable reflector for each of beams 202, 302. For example, a galvanometer actuated reflector may be employed. Other optical/mechanical devices or elements may also be employed, including known piezo electric activated optical elements or other optical and/or mechanical devices or elements. Accordingly, as used herein opto-mechanical element refers to all such elements or devices which can provide a vertical shifting of the light beams needed to cover the vertical range of the display. As noted above, an interlaced scanning system as described in the '945 patent application may be employed to minimize the amount of vertical shifting of the light beams. In an alternate embodiment, vertical shifting of the beams may be provided by tilting the facets on reflector 32. Suitable modifications for such an embodiment will be appreciated from the disclosures of the '440 patent and other patents and applications incorporated herein by reference.

The optical path for beams 202, 302 from each light beam source 200, 300 is configured such that the light beams intercept the rotating polygon 32 in a manner so as to provide a desired scan range across display screen 206 as the polygon rotates and such that the vertical displacement of the lines is accomplished using the optical mechanical element 216, 316 for each optical path. The optical paths will depend on the specific application and as illustrated may comprise collimating optics 208, 308 and projection optics 210, 310 respectively provided for light beams 202, 302 so as to focus the beams with a desired spot size on display screen 206. Also, the optical paths may employ common (or separate) reflective optical element 212 to fold the optical path. Also, the projection optics may include a large Fresnel lens 240 in front of screen 206. Each of collimating optics 208, 308 and projection optics 210, 310 may comprise one or more lenses and one or more reflectors. The particular embodiment shown is merely one example and the number, configuration and dimensions of the optical elements will vary for the particular application. In the particular illustrated embodiment, collimating optics for the first beam path comprises mirror 222, lens 224, lens 226, lens 228, mirror 230, lens 232 and lens 234. Collimating optics for the second beam path comprises mirror 322, lens 324, lens 326, lens 328, mirror 330, lens 332 and lens 334. The collimated beams are provided to first optical mechanical element 216 and second optical mechanical element 316, respectively, which may comprise any suitable element for vertically shifting the light beams as described above. The beams for the first beam path are then provided, via polygon 32, to projection optics 210 which may comprise lens 236 and mirror 238, mirror 212 and Fresnel lens 240 which provide the beams to display screen 206. The beams for the second beam path are in turn provided, via a different facet of polygon 32, to projection optics 310 which may comprise lens 336, mirror 338, mirror 212 and Fresnel lens 240.

It will be appreciated that a variety of modifications to the optical path and optical elements illustrated in FIG. 2B are possible. For example, each of the lenses of collimating optics 208, 308 may be arranged in a collinear compact configuration instead of an L-shaped configuration as shown. Also, additional optical elements may be provided to increase the optical path length or to vary the geometry to maximize scan range in a limited space application. Alternatively, the optical path may not require any path extending elements such as reflective element 212 in an application allowing a suitable geometry of beam sources 200, 300, reflector 32 and screen 206. Similarly, additional focusing or collimating optical elements may be provided to provide the desired spot size for the specific application. In other applications the individual optical elements may be combined for groups of beams less than the entire set of beams in each path. For example, all the diodes in a single row of a diode array may be focused by one set of optical collimating elements. In yet other applications, the focusing elements may be dispensed with if the desired spot size and resolution can be provided by the light beams emitted from the diode arrays 200, 300 itself. The screen 206 in turn may be either a reflective or transmissive screen with a transmissive diffusing screen being presently preferred due to the high degree of brightness provided.

Next referring to FIGS. 3-5 the improved projection optics of the present invention will be described.

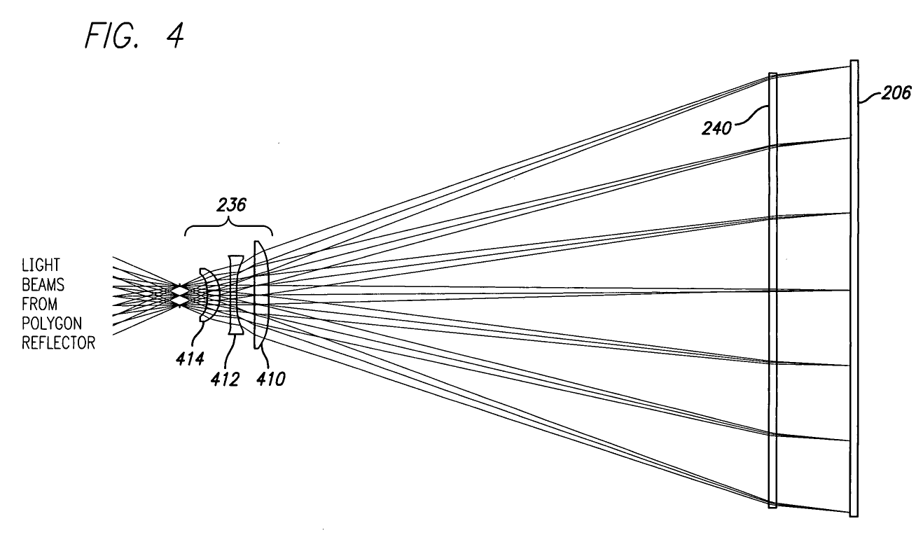

FIGS. 3 and 4 illustrate two embodiments of the projection optics employing a scan line nonlinearity distortion correction lens for projection lens 236 (and 336) which correct the scan line bowing discussed above. FIGS. 3 and 4 show the path of the light beams received from polygon reflector 32 (shown in FIG. 2B) through the projection lens 236 to screen 206. The mirror or mirrors forming part of the projection optics are not shown as they do not actively affect the light beams and merely fold the beam path (where needed for a compact configuration of the optics). As shown, a plurality of beams may simultaneously illuminate a single pixel on screen 206. In particular, in a color display all three diodes in a single row of the diode array may simultaneously illuminate a single pixel. Even in a monochrome display application plural beams may be combined at a single pixel to provide increased brightness. This combination of plural beams to a pixel is implied by the three beams illustrated generally in FIGS. 3 and 4 being directed to each scan line on display 206, each of which preferably includes different frequency or color. FIG. 4 represents an alternative more compact implementation of lens 236 which may be preferred for applications with minimal available space for the optics. FIG. 4 also shows Fresnel lens 240 which reduces the angle at which the light beams hit the screen 206. As shown in FIGS. 3 and 4 the projection lens 236 may preferably include plural separate lens elements. This allows a conventional focusing function and a scan line bowing correction function to be combined in the projections lens. Specifically, as illustrated three lens elements 402, 404 and 406 may comprise the projection lens 236 in the embodiment of FIG. 3 and three lens elements 410, 412 and 414 in the embodiment of FIG. 4, each of which elements may contribute to the scan line bowing correction. (Fresnel lens 240 will in general not be used for such scan line bow correction, however.) It should be appreciated, however, that the scan line bow correction and focusing functions may be separated. Also, all the scan line correction may be provided in a single lens element. Also, more than three lens elements may be employed.

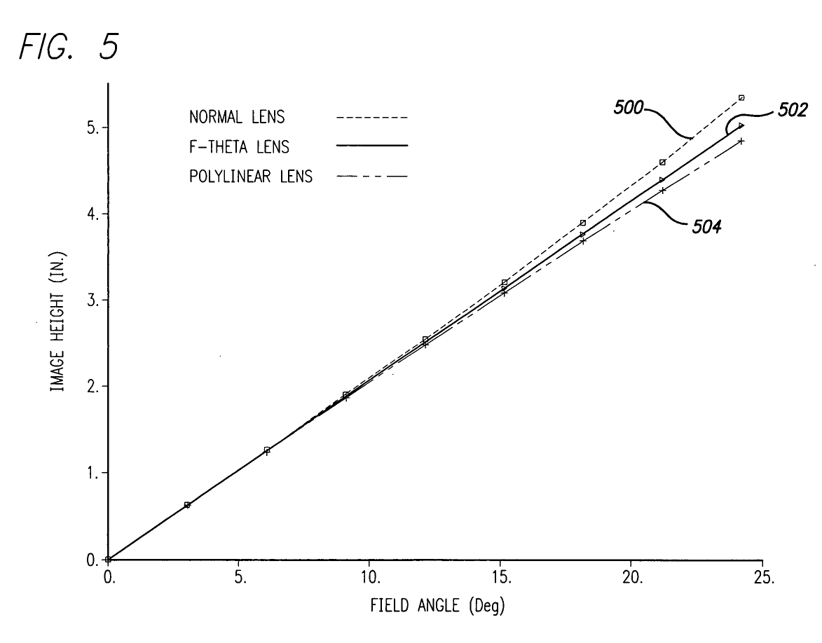

FIG. 5 illustrates a lens distortion graph comparing the lens 236 to a conventional distortion free lens and an f-theta lens. It has been determined that the scan line bowing distortion caused by the polygon for out-of-scan-plane field points was greater than the distortion of an f-theta lens, but with the same sign (in this case negative, or under-corrected distortion). Therefore, the curved or bowed scan lines caused by the polygon can be corrected with a projection lens with enough distortion. However, the horizontal scan speed, which is preferably the same for all cross-scan field angles, will be made variable by the distortion necessary to make the horizontal lines parallel introducing vertical pixel line distortion. Fortunately, for a raster-scanned display application, e.g., as in the presently preferred application, each line is made by a separate source, and the timing can be varied to correct the induced distortion of vertical lines. It is then preferable to trade vertical pixel line distortion for horizontal scan line distortion. (The timing correction for correcting this vertical pixel line distortion will be described below in relation to FIGS. 6-10.) The use of aspheric surfaces can produce the required distortion to straighten the horizontal scan lines, and this solution is preferred. A combination of aspheric and diffractive surfaces may also be used. FIGS. 3 and 4 show this aspheric design.

The lens distortion graph of FIG. 5 shows a preferred amount of distortion of lens 236 at almost twice that of an f-theta lens for large field angles. The lens 236 has been labeled a “polylinear” lens in FIG. 5 as a shorthand since no term exists in the art for a lens of such characteristics. Table 1 below lists specific data values corresponding to FIG. 5. As will be appreciated by those skilled in the art, the distortion amount corresponds to the difference in image height from the normal (zero distortion) value for a given field angle.

TABLE 1

| Field Angle | | | |
|---|---|---|---|
| (Degrees) | Normal | F-Theta | Polylinear |
| 0 | 0.00000 | 0.00000 | 0.00000 |
| 3 | 0.62889 | 0.62832 | 0.62350 |
| 6 | 1.26125 | 1.25664 | 1.24590 |
| 9 | 1.90061 | 1.88500 | 1.86560 |
| 12 | 2.55068 | 2.51327 | 2.48030 |
| 15 | 3.21539 | 3.14160 | 3.08770 |
| 18 | 3.89904 | 3.77000 | 3.68640 |
| 21 | 4.60637 | 4.39823 | 4.27510 |
| 24 | 5.34274 | 5.02655 | 4.85250 |

Although FIG. 5 and Table 1 illustrates a preferred distortion curve for the polylinear lens, one skilled in the art will readily appreciate that a range of distortion values may be suitable for different applications. Table 2 below illustrates a preferred range of distortion values (image height difference from a nondistorting f-tan theta lens) along with the values for an f-theta lens for comparison purposes.

TABLE 2

| Field Angle | F-tan | | Polylinear | Polylinear |
|---|---|---|---|---|
| (Degrees) | Theta | F-Theta | Nominal | Max |
| 0 | 0.00 | 0.00 | 0.00 | 0.00 |
| 4 | 0.00 | −0.17 | −0.99 | −1.24 |
| 8 | 0.00 | −0.65 | −1.64 | −2.05 |
| 12 | 0.00 | −1.47 | −2.77 | −3.47 |
| 16 | 0.00 | −2.61 | −4.42 | −5.55 |
| 20 | 0.00 | −4.10 | −6.56 | −8.20 |
| 24 | 0.00 | −5.92 | −9.16 | −11.45 |
| 28 | 0.00 | −8.09 | −12.21 | −15.27 |

Lenses are normally designed with as little distortion as possible, unless there is a very good reason to allow some amount. F-theta lenses are used with polygon scanners to yield a constant scan rate with polygon scan angle. Although any distortion greater than an f-theta lens may help reduce scan line bowing, at least about 10% greater distortion is desirable. Therefore, the minimum of the range, although not shown in Table 2, may generally be about 10% greater distortion than an f-theta lens. The polylinear scan lens preferably has a nominal distortion of about 50% more distortion than an F-theta lens, at about 20-28 degrees of field angle. More generally, the present invention may employ lenses that are in excess of 10% larger distortion than an F-Theta lens, and less than 500% larger distortion than f-theta, through a horizontal field angle of 8-28 degrees (see Table 2). At lower field angles the distortion as a percentage may vary greatly due to the small difference values involved. This distortion range may generally include even larger field angles if needed for a particular application. Therefore, the field angle ranges above are not meant to be a limitation on scan angle.

As a specific example Table 3 below illustrates a prescription for the polylinear projection lens of FIG. 3. One skilled in the art will readily appreciate the Table entries for the surfaces of the three lens elements of FIG. 3. Where relevant the units are inches. Columns A-D correspond to aspheric coefficients.

TABLE 3

| Curvature | Thickness | Material | A | B | C | D |
|---|---|---|---|---|---|---|
| −0.502533 | 0.5000 | acrylic | −5.49234E−02 | 7.68573E−02 | −1.99791E−02 | 4.65491E−03 |
| −0.891861 | 0.0200 | | −3.10406E−01 | 6.18072E−01 | −7.37592E−01 | 1.74596E−01 |
| −0.988985 | 0.2400 | styrene | −1.72975E−01 | 6.20081E−01 | −7.41854E−01 | 2.13168E−01 |
| −0.759197 | 4.2000 | | 5.63112E−02 | 4.46269E−02 | −6.58961E−02 | 2.36214E−02 |
| Infinity | 0.3200 | acrylic | | | | |
| 0.080195 | 7.8000 | | −4.54006E−03 | 2.76258E−04 | −1.39670E−05 | 3.42733E−07 |

Table 4 below shows the prescription for the projection lens 236 of FIG. 4 and also includes Fresnel lens 240.

TABLE 4

| Curvature | Thickness | Material | A | B | C | D |
|---|---|---|---|---|---|---|
| −0.454545 | 0.4000 | acrylic | −4.07347E−01 | 4.64067E−01 | −2.54344E+00 | 2.14897E+00 |
| −0.466672 | 0.3478 | | −715164E−01 | 7.26280E+00 | −1.09087E+00 | 3.92883E−01 |
| 0.138573 | 0.2000 | styrene | −2.91635E−01 | 3.17474E−01 | −1.07365E−01 | −2.05847E−03 |
| 0.087865 | 0.5810 | | 9.98597E−02 | 4.29670E−02 | −5.93997E−02 | 1.30654E−02 |
| 0.163959 | 0.4600 | acrylic | | | | |
| 0.037485 | 16.2700 | | −6.84500E−02 | 1.65831E−02 | −4.56602E−02 | 4.27866E−04 |
| infinity | 0.2000 | acrylic | | | | |
| fresnel | 2.4000 | | | | | |

It will be appreciated these specific prescriptions are merely illustrative, specific examples and a variety of different specific lens structures are possible.

While the post-scan optics alone create the correction for the display to function for polygon scan distortion, additional compensation may be required with an extended uniformly spaced light source such as a diode array. Since the post-scan optics have a significant amount of optical distortion to correct the scan distortion, if undistorted collimator optics (pre-scan lens) is used to inject the light array onto the polygon, the result would be a display whose line spacing varied along the distortion curve of the projection lens. In order to provide a display with uniform line spacing, it is necessary to duplicate the distortion of the projection lens in the collimating lens so that the collimating and projection optics distortion cancel. In this condition, a linear light source array spacing will be displayed at the screen as a uniformly spaced raster. The pre-scan collimating optics may for example be strongly aspheric in order to create this amount of distortion and still maintain good optical correction (resolution). Based on the foregoing details of the polylinear projection lens such collimating lens distortion may be readily determined for the specific polylinear lens implementation and configuration/number of collimating lens elements.

Next referring to FIGS. 6-10 the use of timing correction to correct scan line length variation introduced by the polylinear lens will be described.

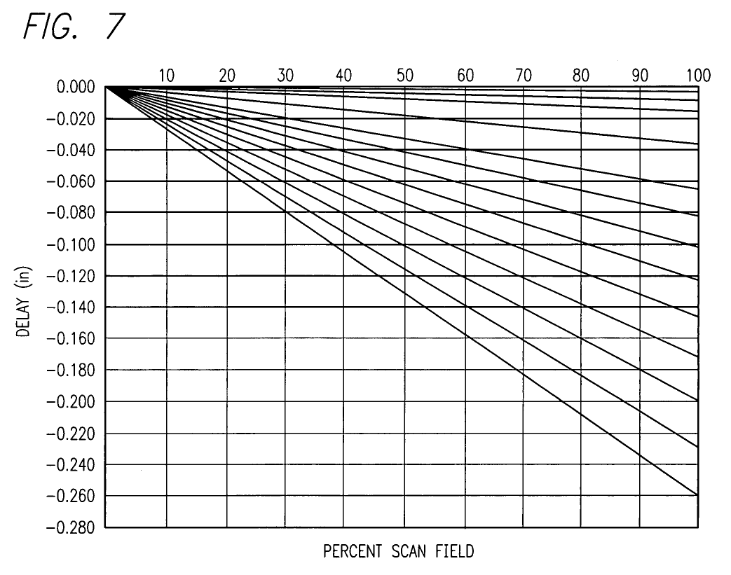

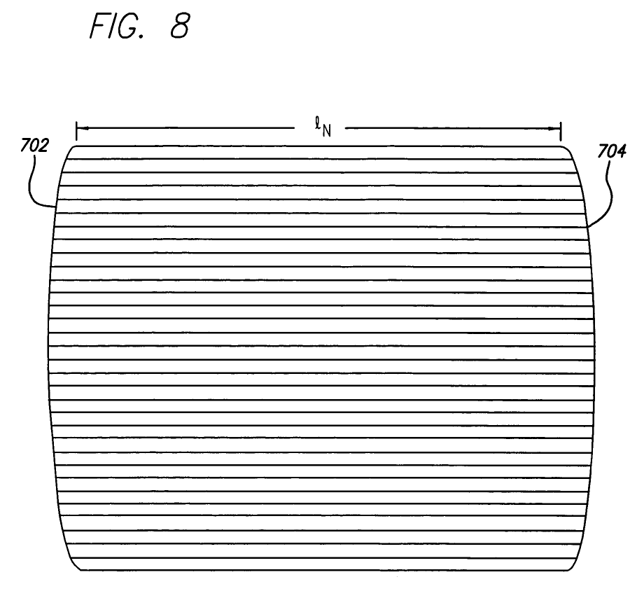

Although the horizontal scan line bowing can be corrected by the projection optics as described above a vertical pixel line distortion will appear due to variations in scan line length. This is illustrated in FIG. 8. As shown the horizontal scan lines have a length Iₙ which varies from a nominal desired length I depending on the distance of the scan line from the center line of the display (or panel of the display for plural beam sources). This results in bowed vertical pixel lines illustrated by bowed vertical edges 702, 704 in FIG. 8. In order to produce straight vertical lines, the scan lines must produce equal pixel spacings. One preferred method of accomplishing this is by electronically providing a distinct pixel clock for each scan line. A block diagram of the timing electronics of electronics 220 is illustrated in FIG. 6. The scan rates that are produced for the various cross-scan field positions vary nonlinearly with distance from the field center, but each line has a virtually linear rate along its length. FIG. 7 shows the resulting scan rate adjustments as a function of the line position for lines in one example representing equally spaced lines or image heights (e.g. spaced eight lines apart) in both a 4:3 and a 16:9 aspect ratio field. This graph measures the scan length error as the difference in scan line length as a function of display height. This corresponds to the correction implemented by the control electronics.

More specifically, referring to FIG. 6, as shown the control electronics receives the video signal from source 100 (FIG. 2A) which may be in either analog or digital form, depending on the application. Also, the display electronics may have dual inputs 600 and 601 allowing use with either analog or digital video inputs. The analog signal is first provided to a analog to digital signal converter 602 and then to block 604. The digital input is provided directly to block 604. Block 604 splits the input video signal into separate signals for each panel of the display. In general, N separate panels may be provided. Since each panel operates in the same manner the following discussion will simply describe a single panel.

Each panel of video data is transferred from block 604 to a respective scan panel frame buffer 606. Once the video signal has been properly distributed to each scan panel frame buffer, the pixel clock for each scan line is converted by pixel clock converter 608. Generally the scan line timing adjustment may be calculated as follows. First the correct facet time is calculated for the specific system using: (Polygon rotational speed/number of facets)×optical scan efficiency. For example, a display system with 60 frames per second, 8 facets on the polygon and 50% optical scan efficiency has the maximum facet time of 1.0417 ms as shown below:

60 Hz polygon rotation=>16.667 ms

Number of facets (8 facets)=>16.667 ms/8=2.083 ms

Scan Efficiency (50%)=>2.083 ms×0.5=1.0417 ms

Next the slowest pixel time is calculated as the following: Slowest pixel time=Max. facet time/number of pixels per scan line. In the same example above, if the system requires 320 pixels per scan line:

Slowest pixel time=1.0417 ms/320 pixels=3.2552 μs per pixel

Next the fastest pixel time is calculated. This is achieved by calculating the percent difference between the longest scan line length and the shortest scan line length. The fastest pixel time is the percent difference faster than the slowest pixel time: Fastest pixel time=Slowest pixel time−(slowest pixel time× % difference). In the same example above, if the percent difference is 5.25%:

Fastest pixel time=3.2552 μs per pixel−(3.2552 μs per pixel×0.0525)=3.0843 μs/pixel

The system electronics must be able to produce a pixel clock rate at the calculated fastest pixel time or faster. Pixel times for all scan lines are calculated by applying the proper percent difference between that scan line and the fastest scan line.

Scan line pixel time=fastest pixel time+(fastest pixel time× % difference)

By applying the proper pixel times for each scan line, every scan line will have equal scan line lengths.

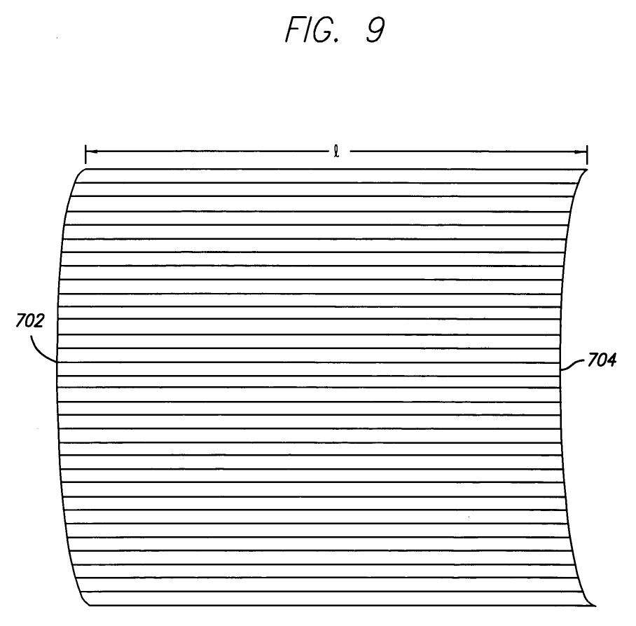

FIG. 9 illustrates the video output after converting the pixel clock for each scan line. Each line now has the same length 1. As a result the bow of edge 702 is mirrored in a bow in edge 704 as illustrated.

Next, the timing correction to ensure each scan line starts at the same horizontal position on the screen will be described. This is accomplished by start of line converter 610 which applies the proper start of line delays for each scan line. The scan line with the fastest pixel time will not need any delay. The scan line with the longest scan line will require the longest delay. The required delay for each scan line may be calculated as follows. First the difference between the start point of the fastest scan line and the current scan line is calculated. Then that length is converted into a number of pixels for that line. Then the delay time is calculated by converting the number of pixels to delay the start of line into the delay time.

In the same example above, if the equalized scan line length is 14 inches and since there are 320 pixels per scan line, each pixel space is 14 inches/320 pixels=0.04375 inches per pixel. If the fastest scan line starts 0.45 inches left of the slowest scan line, then the slowest scan line must be delayed by 0.45 inches or 0.45 inches/0.04375 inches per pixel=10.29 pixels. Since the fastest scan line has the pixel time of 3.0843 μs per pixel, 10.29 pixels will require 10.29 pixels×3.0843 μs/pixel=31.7242 μs delay for its start of line.

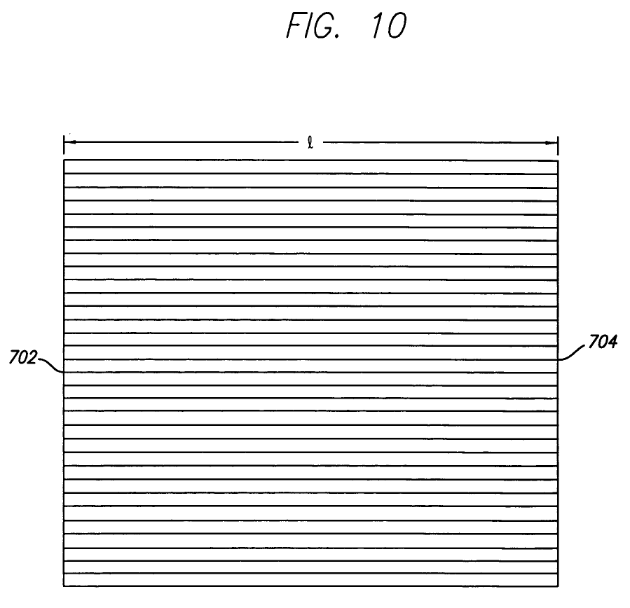

By applying the same calculation for each scan line, all scan lines within the scan panel will start at the same horizontal position and produce a video output as illustrated in FIG. 10.

The present invention thus provides a light beam display which employs one or more post scan optical elements with a large amount of optical distortion to compensate the scan line nonlinearity distortion or scan line bowing of the polygon scanner in the light beam display. In general any lens that has optical distortion of a magnitude greater than that of an f-theta lens could be employed in a polygon-scanned system and will provide some improvement. The only reason to produce such a lens would be to correct polygon induced scan line bow. Nonetheless, preferred embodiments and ranges for such a correction lens have been described in detail. These specific examples should not be viewed as limiting in nature. Also, a specific example of a correction method for correcting variations in scan line length has been described using pixel clock rate adjustment and start of line adjustment on a line by line basis. This should also not be viewed as limiting as other scan line length normalization techniques could be employed. Also, the correction may be made for groups of lines rather than for each line and the terminology “line by line” includes such embodiments. Other variations and modifications may also be provided. Therefore, while the foregoing detailed description of the present invention has been made in conjunction with specific embodiments, and specific modes of operation, it will be appreciated that such embodiments and modes of operation are purely for illustrative purposes and a wide number of different implementations of the present invention may also be made. Accordingly, the foregoing detailed description should not be viewed as limiting, but merely illustrative in nature.

What is claimed is:

1. A light beam display, comprising:
a display screen having a vertical and a horizontal dimension;
a source of one or more light beams;
an optical path between the display screen and the light beam source for directing said one or more light beams to the display screen, including a movable reflector having a plurality of reflective facets for providing horizontal scanning of the light beams and a horizontal scan line distortion correction lens;
an optical mechanical element for vertically shifting the light beams so as to illuminate different scan lines of the display screen; and
control electronics for controlling the scan timing to compensate for varying scan line length introduced by said horizontal scan line distortion correction lens.

2. A light beam display as set in claim 1, wherein the movable reflector is a rotatable polygon.

3. A light beam display as set in claim 1, wherein the horizontal scan line distortion correction lens has optical distortion substantially greater than an f-theta lens.

4. A light beam display as set out in claim 1, wherein said horizontal scan line distortion correction lens has maximum optical distortion in a range between about 10% greater distortion and 500% greater distortion than an f-theta lens through a horizontal field angle of 8-28 degrees.

5. A light beam display as set out in claim 4, wherein said horizontal scan line correction lens comprises an aspheric lens.

6. A light beam display as set out in claim 3, wherein said optical path further comprises a collimating lens.

7. A light beam display as set out in claim 6, wherein said light beam source comprises an array of LED's and wherein said collimating lens introduces distortion into the plural light beams substantially opposite to said horizontal scan line distortion correction lens.

8. A light beam display as set out in claim 7, wherein said horizontal distortion correction lens is configured in the optical path between the display screen and movable reflector and the collimating lens is configured in the optical path on the opposite side of the movable reflector.

9. A light beam display as set out in claim 8, wherein said horizontal distortion correction lens is an assembly of lens elements collectively providing the desired distortion.

10. A light beam display as set out in claim 1 further comprising an input for receiving video data, the video data including a plurality of horizontal lines of display information and wherein said control electronics comprises a memory for storing video data and a timing control circuit for controlling timing of read out of video data from the memory in accordance with the horizontal line number of said video data.

11. A light beam display as set out in claim 10, wherein said timing control circuit comprises:
a pixel clock converter for adjusting the pixel clock for each scan line; and
a start of line converter for adjusting the start timing for each scan line.

12. A light beam display as set out in claim 11, wherein said pixel clock converter increases the pixel clock rate for scan lines closer to the edge of the display.

13. A light beam display as set out in claim 11, wherein the start of line converter provides a variable delay as the scan lines are closer to the edge of the display.

14. A method of displaying information on a display screen employing one or more light beams, comprising:
directing a light beam to the display screen via an optical path including a movable reflector having plural reflective facets;
scanning the light beam in a horizontal direction using the movable reflector to trace out a horizontal scan line;
distorting the light beam while traversing said optical path to correct nonlinearity in the horizontal scan line introduced by the movable reflector;
shifting the light beam in the vertical direction; and
adjusting the timing of the scanning based on the vertical position of the horizontal line in the screen to correct scan length distortion.

15. A method of displaying information on a display screen employing one or more light beams as set out in claim 14, wherein said adjusting of the timing is performed on a line by line basis.

16. A method of displaying information on a display screen employing one or more light beams as set out in claim 14, wherein said adjusting of the timing comprises controlling the rate of read out of horizontal lines of video information from a video memory based on the horizontal line being scanned.

17. A method of displaying information on a display screen employing one or more light beams as set out in claim 16, wherein the read out rate is altered nonlinearly with horizontal line number.

18. A method of displaying information on a display screen employing one or more light beams as set out in claim 16, wherein said adjusting of the timing further comprises controlling the start of line timing based on the horizontal line being scanned.

19. A method of displaying information on a display screen employing one or more light beams as set out in claim 14, wherein said distorting the light beam comprises providing a distortion greater than an f-theta lens.

20. A method of displaying information on a display screen employing one or more light beams as set out in claim 19, wherein the distortion is between about 10% and 500% greater than the distortion of an f-theta lens through a horizontal scan field angle of about 8-28 degrees.

21. A method of displaying information on a display screen employing one or more light beams as set out in claim 14, wherein said movable reflector is a rotatable polygon.

22. A light beam scanning system, comprising:
a source of one or more light beams;
a rotatable polygon having a plurality of reflective sides, configured to intercept said one or more light beams and scan said one or more light beams in a first direction to create a first scan line;
means for shifting the one or more beams to create plural additional scan lines displaced in a second direction from said first scan line;
means for distorting the one or more light beams to correct bowing of the scan lines and introducing distortion in the second direction; and
timing means for correcting the distortion in the second direction.

23. A light beam scanning system as set out in claim 22, wherein said means for distorting comprises a lens having distortion greater than an f-theta lens.

24. A light beam scanning system as set out in claim 23, wherein said means for distorting comprises a lens having distortion between about 10% and 75% greater than an f-theta lens through at least a portion of the field angle.

25. A light beam scanning system as set out in claim 22, wherein said timing means provides a variable timing delay based on the amount of shifting of the scan lines in the second direction.

26. A light beam scanning system as set out in claim 22, wherein said timing means provides a variable pixel clock rate based on the amount of shifting of the scan lines in the second direction.

27. A method for correcting scan line bowing in a rotatable polygon reflector light beam scanning system, comprising:
distorting the light beam by an amount substantially greater than the distortion provided by an f-theta lens to remove the scan line bow introduced by the rotatable polygon reflector; and
correcting scan line length variation introduced by said distorting.

28. A method for correcting scan line bowing as set out in claim 27, wherein said distorting provides a maximum distortion between about 10% and 500% greater than the maximum distortion of an f-theta lens through a field angle of 8-28 degrees.

29. A method for correcting scan line bowing as set out in claim 27, wherein said correcting scan line length variation comprises adjusting the start of line timing.

30. A method for correcting scan line bowing as set out in claim 29, wherein said correcting scan line length variation further comprises adjusting the scan line length by adjusting a pixel clock rate for the scan line.
